(19) United States
(12) Patent Application Publication
(10) Pub. No.: US 2021/0278698 A1
(43) Pub. Date: Sep. 9, 2021

(54) COMFORT FIT SLIP-RESISTANT EYEWEAR SYSTEM

(71) Applicant: LooLoops, LLC, Scottsdale, AZ (US)

(72) Inventors: Kent Chill Loo, Scottsdale, AZ (US); Joseph Pepe Elijio Velasquez, Tempe, AZ (US); Daniel W Allen, Mesa, AZ (US); Joseph M Barrett, Tempe, AZ (US)

(73) Assignee: LooLoops, LLC, Scottsdale, AZ (US)

(21) Appl. No.: 17/192,505

(22) Filed: Mar. 4, 2021

Related U.S. Application Data
(60) Provisional application No. 62/985,210, filed on Mar. 4, 2020.

(51) Int. Cl. G02C 5/12

(52) U.S. Cl. CPC G02C 5/126

(57) ABSTRACT

A slip-resistant eyewear system comprising a nose pad comprising a securing member configured to couple to a portion of an eyewear frame and a flap pivotally coupled to the securing member, wherein an angle formed between the securing member and the flap is an acute angle. Implementations of a flap-style nose pad may comprise a pocket configured to house a preexisting eyewear nose pad therein. Other implementations of the nose pad may be configured to adhere to a preexisting eyewear frame. Use of a higher durometer and material and a lower durometer material to form the nose pads allows for a custom fit to accommodate wearers of varying facial topography avoid slippage of the eyewear system.

### CROSS REFERENCE TO RELATED APPLICATIONS

This application claims priority to U.S. Provisional Patent Application No. 62/985,210 filed on Mar. 4, 2020, entitled “Comfort Fit Slip-Resistant Eyewear System” to Loo, et al., the contents of which is hereby incorporated by reference in its entirety.

### BACKGROUND

### 1. Field of the Invention

Exemplary embodiments generally relate to an eyewear system design for enhanced user comfort and slip resistance.

### 2. Related Art

Eyewear is generally designed to fit a pre-determined face shape and anatomical structure, which causes many wearers to experience a poor fit, which is particularly the case for people who lack prominent facial and nasal bridge structures. Conventional eyewear typically relies on two hard nose pads that rest on either side of the nose to support the eyewear; however, many wearers find these hard nose pads to be uncomfortable and inadequate to hold the eyewear in a proper position without slipping, sliding, or leaving marks on the user's nasal bridge after removal.

### SUMMARY

Implementations of a slip-resistant eyewear system may comprise a nose pad comprising a securing member configured to couple to a portion of an eyewear frame and a flap pivotally coupled to the securing member, wherein an angle formed between the securing member and the flap is an acute angle.

Particular aspects may comprise one or more of the following features. The flap may be configured to pivot toward the securing member when the eyewear frame is worn by a user. The flap may be comprised of a material having a durometer range of less than about Shore 40A on the Shore A hardness scale. The securing member and the flap may be integrally formed. The securing member may be substantially planar and may further comprise an adhesive configured to adhere to the portion of the eyewear frame. The securing member may be configured to seat within a notched indentation on the eyewear frame. The nose pad may be comprised of a core comprised of a material having a durometer range greater than about Shore 40A on the Shore A hardness scale. The nose pad may be comprised of an outer layer comprising a material having a durometer less than about Shore 40A on the Shore A hardness scale. The flap may comprise a bulbous tip. The flap may comprise a tapered tip. The securing member may comprise a plurality of slots. The securing member may comprise a pocket configured to house a pre-existing nose pad coupled to the eyewear frame. The securing member may comprise a hollow portion. A hinge between the securing member and the flap may comprise one or more notches. A hinge between the securing member and the flap may comprise one or more slots. The flap may further comprise one or more ribs on a surface of the flap that faces the securing member.

Implementations of a method of making a slip-resistant eyewear system may comprise forming a nose pad, the nose pad comprising a securing member configured to couple to a portion of an eyewear frame and a flap pivotally coupled to the securing member, wherein an angle formed between the securing member and the flap is an acute angle. The method may further comprise coupling the securing member to the eyewear frame.

Particular aspects may comprise one or more of the following features. The flap may be configured to pivot toward the securing member when the eyewear frame is worn by a user. The method may further comprise adhering the securing member to the portion of the eyewear frame using an adhesive. The method may further comprise seating a pre-existing nose pad of the eyewear frame within a pocket of the securing member.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Brief Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein. Elements and acts in the figures are illustrated for simplicity and have not necessarily been rendered according to any particular sequence or embodiment.

FIGS. 1-28 depict various implementations of flap-style nose pads.

FIGS. 29-32 depict implementations of flap-style nose pads comprising a pocket configured to house a pre-existing nose pad of an eyewear frame.

FIGS. 33-36 depict implementations of flap-style nose pads comprising an adhesive.

FIGS. 37-41 depict an implementation of flap-style nose pads wherein the securing member comprises a hollow.

FIGS. 42-47 depict an implementation of flap-style nose pads comprising a curved edge.

FIGS. 48-51 depict an implementation of flap-style nose pads comprising a notch proximal at least one end of a flap hinge.

FIGS. 52-55 depict an implementation of flap-style nose pads comprising at least one slot along the flap hinge.

FIGS. 56-59 depict an implementation of flap-style nose pads comprising at least one rib along the flap hinge.

FIGS. 60-75 depict implementations of a nosepiece for an eyewear frame.

### DESCRIPTION

This disclosure, its aspects and implementations, are not limited to the specific components or assembly procedures disclosed herein. Many additional components and assembly procedures known in the art consistent with the intended eyewear systems and/or assembly procedures for eyewear will become apparent for use with implementations of the eyewear systems of this disclosure. Accordingly, for example, although particular eyewear systems are disclosed, such eyewear systems and implementing components may comprise any shape, size, style, type, model, version, measurement, concentration, material, quantity, and/or the like as is known in the art for such eyewear systems and implementing components, consistent with the intended operation of eyewear.

Contemplated as part of this disclosure are various embodiments of comfort fit and slip resistant eyewear systems and their respective components. It is noted that although some figures provided herein depict retrofitting existing eyewear systems while other depict custom eyewear frames, the disclosures described herein may be applied to any of a variety of eyewear frames and eyewear systems.

Because of the unique anatomical structure of each person's face, a need exists for a customizable and personalized comfortable eyewear fit. The inventions disclosed herein focus on providing enhanced eyewear comfort, fit, and performance. Any of the inventions disclosed herein may be comprised of an inner core comprising one or more materials having a higher durometer relative to an outer layer or may be comprised solely of the higher durometer material or solely of the soft, lower durometer material. For the purposes of this disclosure, the term higher durometer material is intended to refer to materials within, but not limited to about the following durometer ranges within the Shore A Hardness Scale: greater than about Shore 40A; greater than about Shore 50A; greater than about Shore 60A; greater than about Shore 70A; greater than about Shore 80A; greater than about Shore 90A; about Shore 40A-about Shore 100A; about Shore 40A-about Shore 90A; about Shore 40A-about Shore 80A; about Shore 40A-about Shore 70A; about Shore 40A-about Shore 60A; about Shore 40A-about Shore 50A; about Shore 50A-about Shore 100A; about Shore 50A-about Shore 90A; about Shore 50A-about Shore 80A; about Shore 50A-about Shore 70A; about Shore 50A-about Shore 60A; about Shore 60A-about Shore 100A; about Shore 60A-about Shore 90A; about Shore 60A-about Shore 80A; about Shore 60A-about Shore 70A; about Shore 70A-about Shore 100A; about Shore 70A-about Shore 90A; about Shore 70A-about Shore 80A; about Shore 80A-about Shore 100A; about Shore 80A-about Shore 90A; about Shore 90A-about Shore 100A. An outer layer comprising a soft, low durometer material may surround at least a portion of the inner core of the nose pad or nosepiece to enhance the grip of the nose pad or nosepiece on the user's nasion and/or nasal bridge. For the purposes of this disclosure, the terms soft, low durometer material or low durometer material are intended to refer to materials within, but not limited to, about the following durometer ranges within the Shore A Hardness Scale: Less than about Shore 40A; Less than about Shore 35A; Less than about Shore 30A; Less than about Shore 25A; Less than about Shore 20A; Less than about Shore 15A; Less than about Shore 10A; Less than about Shore 5A; about Shore 0A-about Shore 40A; about Shore 0A-about Shore 35A; about Shore 0A-about Shore 30A; about Shore 0A-about Shore 25A; about Shore 0A-about Shore 20A; about Shore 0A-about Shore 15A; about Shore 0A-about Shore 10A; about Shore 0A-about Shore 5A; about Shore 5A-about Shore 40A; about Shore 5A-about Shore 35A; about Shore 5A-about Shore 30A; about Shore 5A-about Shore 25A; about Shore 5A-about Shore 20A; about Shore 5A-about Shore 15A; about Shore 5A-about Shore 10A; about Shore 10A-about Shore 40A; about Shore 10A-about Shore 35A; about Shore 10A-about Shore 30A; about Shore 10A-about Shore 25A; about Shore 10A-about Shore 20A; about Shore 10A-about Shore 15A; about Shore 15A-about Shore 40A; about Shore 15A-about Shore 35A; about Shore 10A-about Shore 30A; about Shore 15A-about Shore 25A; about Shore 15A-about Shore 20A; about Shore 20A-about Shore 40A; about Shore 20A-about Shore 35A; about Shore 20A-about Shore 30A; about Shore 20A-about Shore 25A; about Shore 25A-about Shore 40A; about Shore 25A-about Shore 35A; about Shore 25A-about Shore 30A; about Shore 30A-about Shore 40A; about Shore 30A-about Shore 35A; and about Shore 35A to about Shore 40A and/or the following durometer ranges within the Shore 00 Hardness Scale: less than about 80 Shore 00; less than about 70 Shore 00; less than about 60 Shore 00; less than about 50 Shore 00; less than about 40 Shore 00; less than about 30 Shore 00; less than about 20 Shore 00; less than about 10 Shore 00; about 0 Shore 00-about 80 Shore 00; about 0 Shore 00-about 70 Shore 00; about 0 Shore 00-about 60 Shore 00; about 0 Shore 00-about 50 Shore 00; about 0 Shore 00-about 40 Shore 00; about 0 Shore 00-about 30 Shore 00; about 0 Shore 00-about 20 Shore 00; about 0 Shore 00-about 10 Shore 00; about 10 Shore 00-about 80 Shore 00; about 10 Shore 00-about 70 Shore 00; about 10 Shore 00-about 60 Shore 00; about 10 Shore 00-about 50 Shore 00; about 10 Shore 00-about 40 Shore 00; about 10 Shore 00-about 30 Shore 00; about 10 Shore 00-about 20 Shore 00; about 20 Shore 00-about 80 Shore 00; about 20 Shore 00-about 70 Shore 00; about 20 Shore 00-about 60 Shore 00; about 20 Shore 00-about 50 Shore 00; about 20 Shore 00-about 40 Shore 00; about 20 Shore 00-about 30 Shore 00; about 30 Shore 00-about 80 Shore 00; about 30 Shore 00-about 70 Shore 00; about 30 Shore 00-about 60 Shore 00; about 30 Shore 00-about 50 Shore 00; about 30 Shore 00-about 40 Shore 00; about 40 Shore 00-about 80 Shore 00; about 40 Shore 00-about 70 Shore 00; about 40 Shore 00-about 60 Shore 00; about 40 Shore 00-about 50 Shore 00; about 50 Shore 00-about 80 Shore 00; about 50 Shore 00-about 70 Shore 00; about 50 Shore 00-about 60 Shore 00; about 60 Shore 00-about 80 Shore 00; about 60 Shore 00-about 70 Shore 00; and about 70 Shore 00-about 80 Shore 00.

When this low durometer material is in contact with the user's nasion and/or nasal bridge, gravitational force is acting on the eyewear frame. The vector components of the gravitational force cause the nose pads and/or nosepiece to drag slightly across the skin thereby creating tiny wrinkles known as Schallamach waves on the surface of the low durometer material. These tiny wrinkles reduce slippage of the eyewear down the nasal bridge due to the enhanced frictional forces that they provide. It is to be understood that any of the embodiments of nosepieces or nose pads described herein may be comprised of the aforementioned higher durometer inner core and lower durometer outer layer.

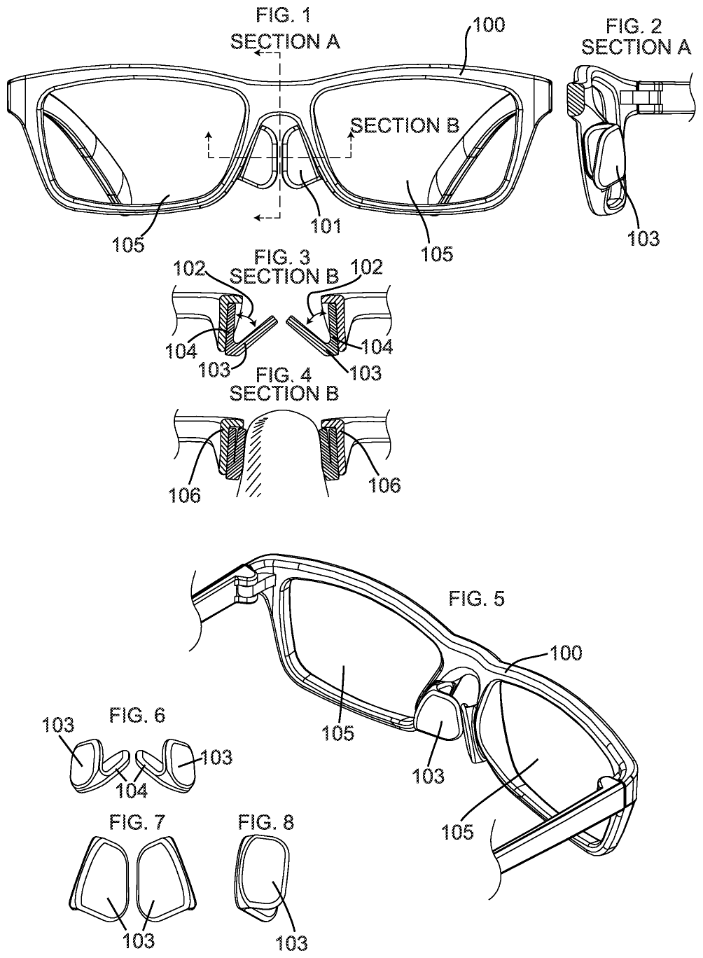

FIGS. 1-75 depict various implementations of nose pads 101 for eyewear frames 100. More specifically, FIGS. 1-8 depict embodiments of a nose pad 101 comprising a flap 103 that extends outward from the eyewear frame 100 and into the open space between the eyewear lenses 105. When the eyewear system is not in use and the flap 103 is in an open position, the flap 103 may form an acute angle 102 relative to the securing member 104 of the nose pad 101 that is affixed to the eyewear frame 100. When a user wears the eyewear system and places the eyewear frame 100 on the user's nose, the flap 103 moves to a compressed position that is proximal the securing member 104 of the nose pad 101 that is affixed to the eyewear frame 100. As a result of this spring-like shape and structure, the nose pads 101 exert a force on the user's nose that creates friction and a secure grip to prevent the eyewear from sliding down the user's nose. While it is contemplated that this flap-style nose pad 101 may be retro fit to existing eyewear frames 100, FIGS. 3-4 provide a cross-sectional view of an implementation of a custom eyewear frame 100 comprising a notched indentation 106 adapted to house the nose pad 101. This allows the nose pad 101 to fold against the eyewear frame 100 into the notch 106 and at least partially be hidden from view to create a streamlined and attractive appearance.

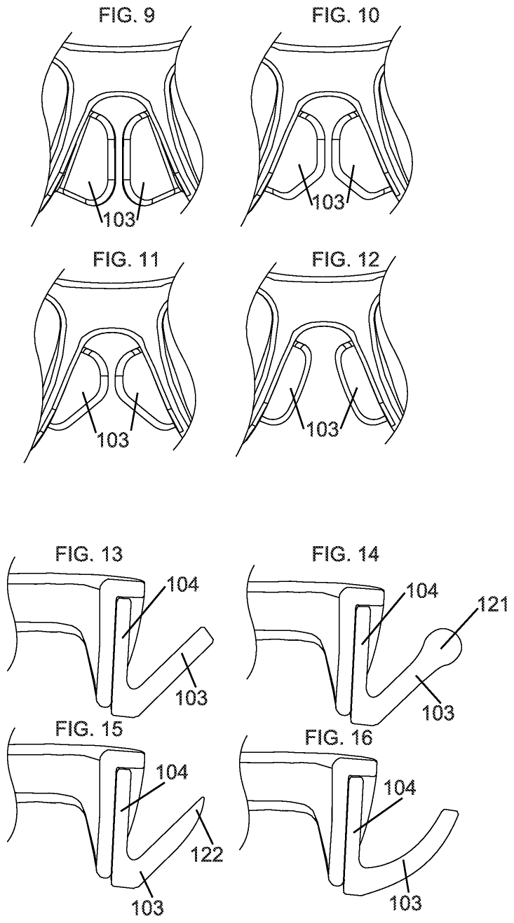

Nose pad flaps 103 may comprise different lengths and/or shapes to allow a user to select a nose pad 101 that best fits the user's particular anatomy, some non-limiting examples of which are provided in FIGS. 9-12 such as a flap comprising a bulbous tip 121 or a tapered tip 122. For example, a user having a less prominent nose may prefer a nose pad 101 comprising a longer flap 103 in order to properly secure the eyewear when in use. FIGS. 13-16 provide cross-sectional views of the nose pads 101 of FIGS. 9-12, respectively, although it is contemplated that these cross-sectional views may be applicable to any of the implementations described in this disclosure. Flaps 103 that are thinner and more tapered may feel softer and allow the frames 100 to sag slightly lower on the user's nasal bridge than those with thicker and more robust flaps 103.

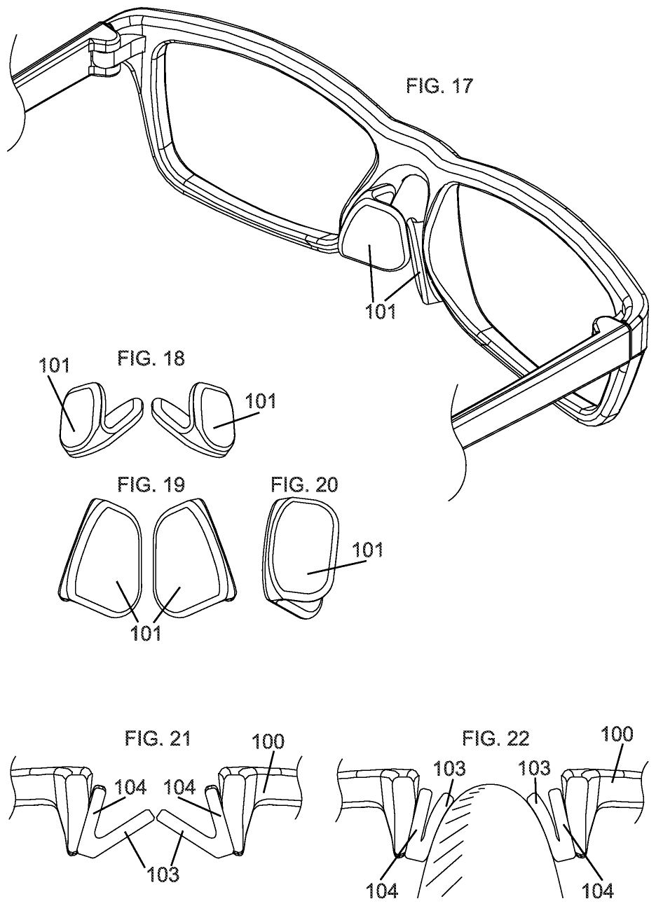

FIGS. 17-22 depict an implementation of a flap-style nose pad 101 that may adhere to preexisting eyewear frames 100. Thus, there is not a custom notch 106 configured to house the nose pad 101 and the nose pad 101 merely adheres directly to the eyewear frame 100. Just as with the embodiments previously discussed, the nose pad flap 103 may comprise any shape, length, or thickness as desired by the user to form a custom fit.

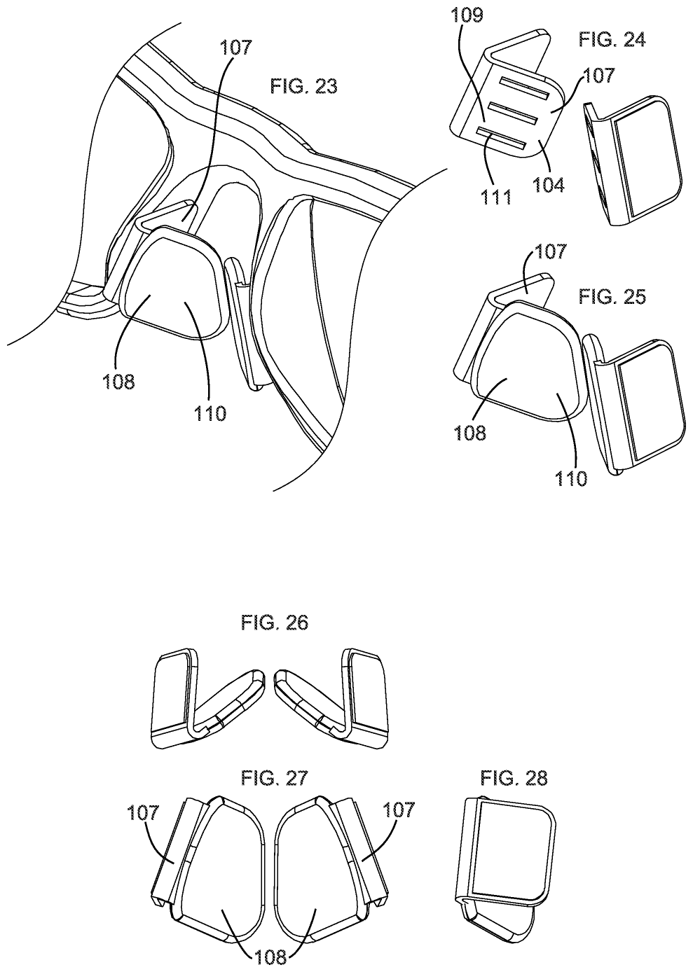

FIGS. 23-28 depict a nose pad 101 implementation in which the nose pad 101 comprises a plurality of materials. A first, higher durometer, rigid material 107 such as by non-limiting example, a hardened plastic, may comprise a spring-like arm 109 with a second, lower durometer material 108 such as by non-limiting example, a silicone or rubber pad 110 on top of the surface of the spring-like arm 109 that is intended to be in contact with the user's nose when the eyewear is in use. The lower durometer material 108 may be adhered to the higher durometer material 107 or may be molded around at least a portion of the rigid arm 109. As depicted in FIG. 24, the rigid spring-like arm 109 may comprise one or more slots 111 therein to facilitate securely molding the lower durometer material 108 to the arm 109 after curing. An outer edge of the rigid arm 109 may further comprise one or more adhesive pads 112 for affixing the nose pad 101 to the eyewear frame 100.

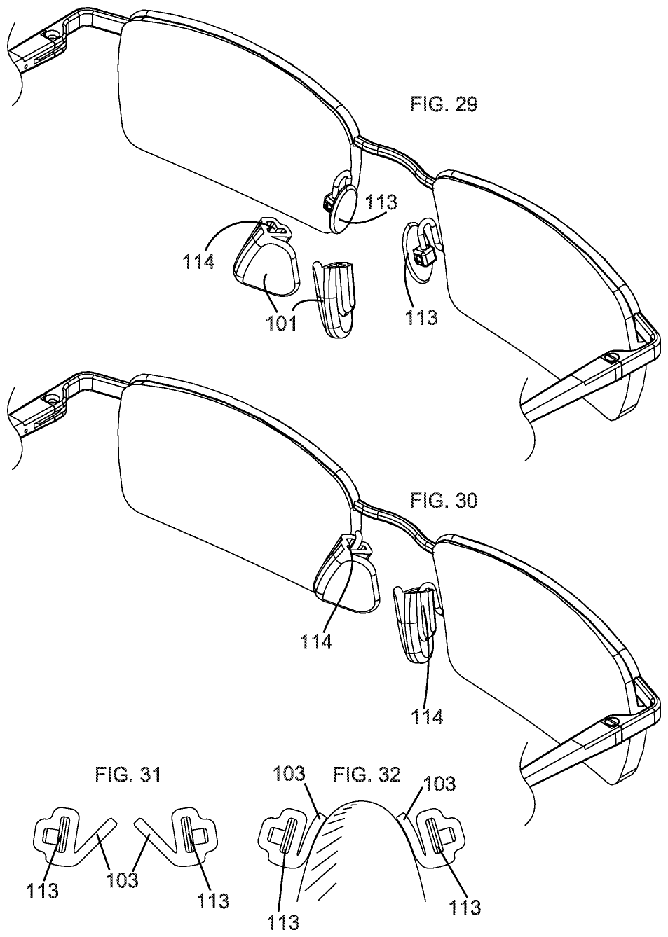

FIGS. 29-32 depict an implementation of a nose pad 101 adapted to slide over a traditional rounded-style nose pad 113 of a preexisting eyewear frame 100. As shown, the nose pad 101 comprises a pocket 114 or sleeve that slides over the preexisting nose pad 113 of the eyewear frame 100.

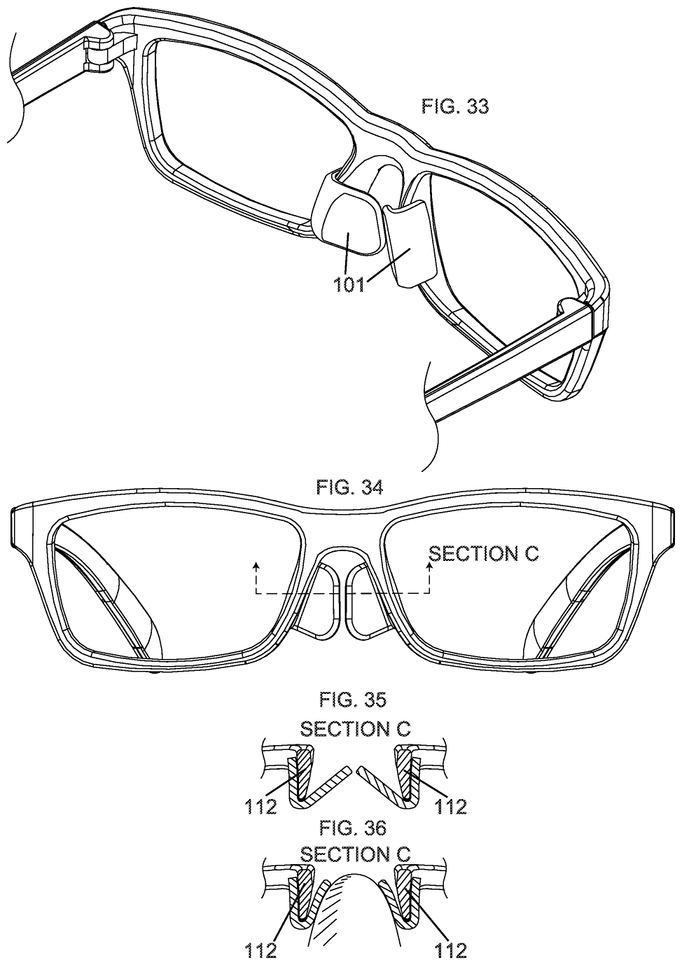

FIGS. 33-36 provide an implementation of a nose pad 101 that comprises an adhesive pad 112 which may be adhered to the eyewear frame 100 itself. As shown, the adhesive 112 may adhere to the outer edge of the eyewear frame 100 proximal the lens 105 to provide additional space to accommodate a user having a more prominent nose; however, it is also contemplated that the nose pad 101 may be configured to adhere to the inner edge of the frame 100 adjacent to the open space occupied by the user's nose.

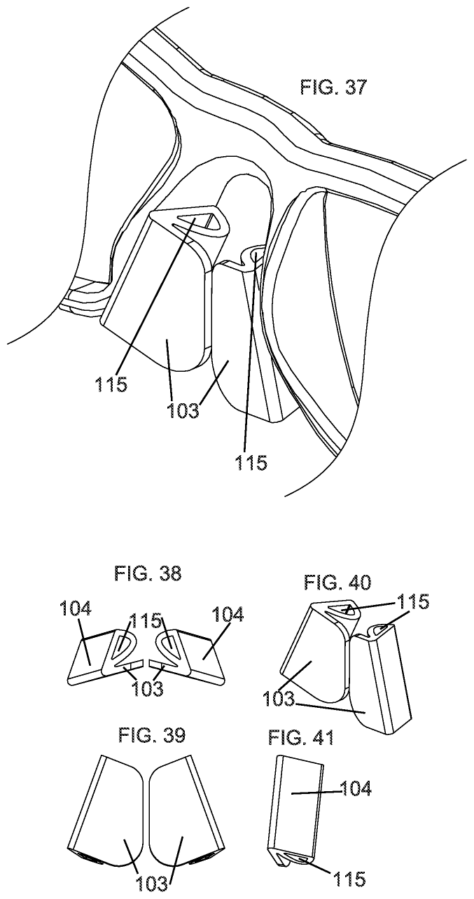

FIGS. 37-41 depict an implementation of a nose pad 101 comprising a D-shaped cross-sectional profile that may adhere or otherwise couple to the eyewear frame 100 as well as a flap 103 in accordance with numerous embodiments of nose pads 101 described above. The D-shaped portion may be comprised of one or more solid materials or as shown, may be comprised of a material forming a hollow 115 which may therefore provide additional spring-like support for the eyewear frame 100 when in use on the nose of a wearer.

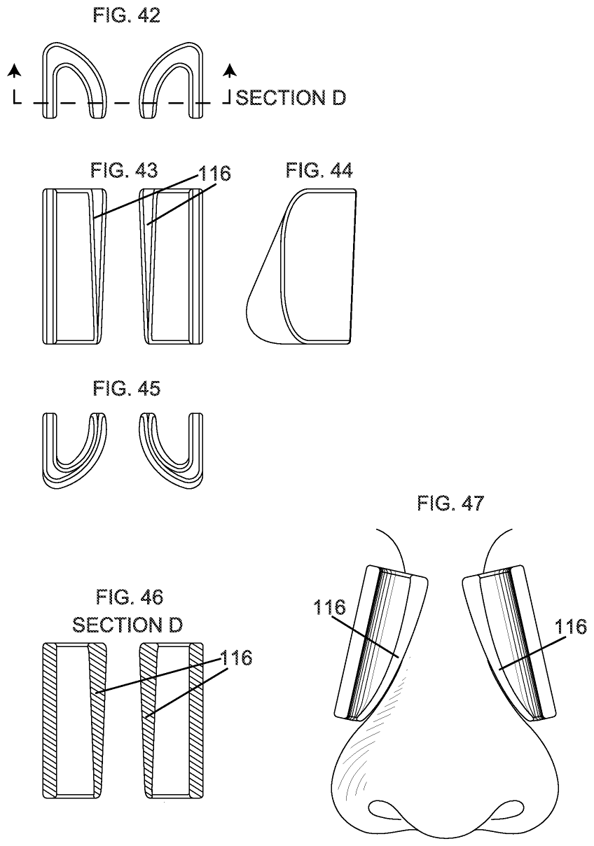

FIGS. 42-47 provide views of various implementation of a flap-style nose pad 101 that may adhere or otherwise attach to an existing eyewear frame 100. As shown, the edge of the flap 103 that faces inward and contacts the user's nose when in use may comprise a curved edge 116 which may aid in creating spring-like support on the user's nose and prevent the flap 103 from folding the wrong way when placed on the user's nose. As shown in the front view of FIG. 43 and in the in-use view of FIG. 47, the curved, inward facing edge 116 of the nose pad may be thicker at the top of the nose pad 101 and thinner at the bottom of the nose pad 101 so as to create a softer bottom corner which is the point at which the nose pad 101 first contacts the nose, thereby allowing the nose pad 101 to better conform to the shape of the user's nose. FIGS. 42 and 44-46 provide top, right, bottom, and cross-sectional views of the nose pad 101, respectively.

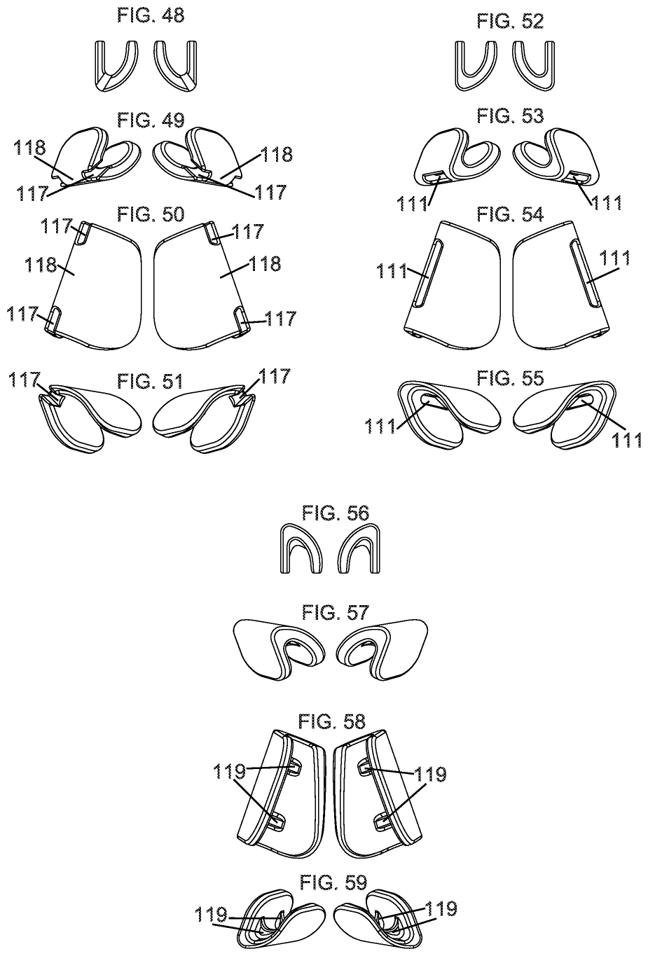

FIGS. 48-51 depict an implementation of a flap-like nose pad 101 comprising a notch 117 on at least one end of the flap hinge 118. This structure allows the nose pad 101 to fold more easily which may result in a softer fit. The length and width of the notch 117 may comprise any suitable dimensions. FIGS. 48-51 provide straight-on, top, back, and bottom views respectively.

FIGS. 52-55 depict an implementation of a flap-like nose pad 101 comprising a slot 111 proximal a center portion of the flap hinge 118 which allows the nose pad 101 to fold more easily, resulting in a softer fit. FIGS. 52-55 provide straight-on, top, back, and bottom views, respectively.

FIGS. 56-59 depict an implementation of a flap-like nose pad 101 comprising one or more ribs 119 on a surface of the nose pad 101 that is on the inside of the nose pad 101 relative to the direction that the nose pad 101 folds when in use. The one or more ribs 119 stiffen the nose pad 101 thereby making it more difficult for the nose pad 101 to fold. This gives the nose pad 101 a firmer feel which may be preferred by some users. FIGS. 56-59 provide straight-on, top, front, and bottom views, respectively.

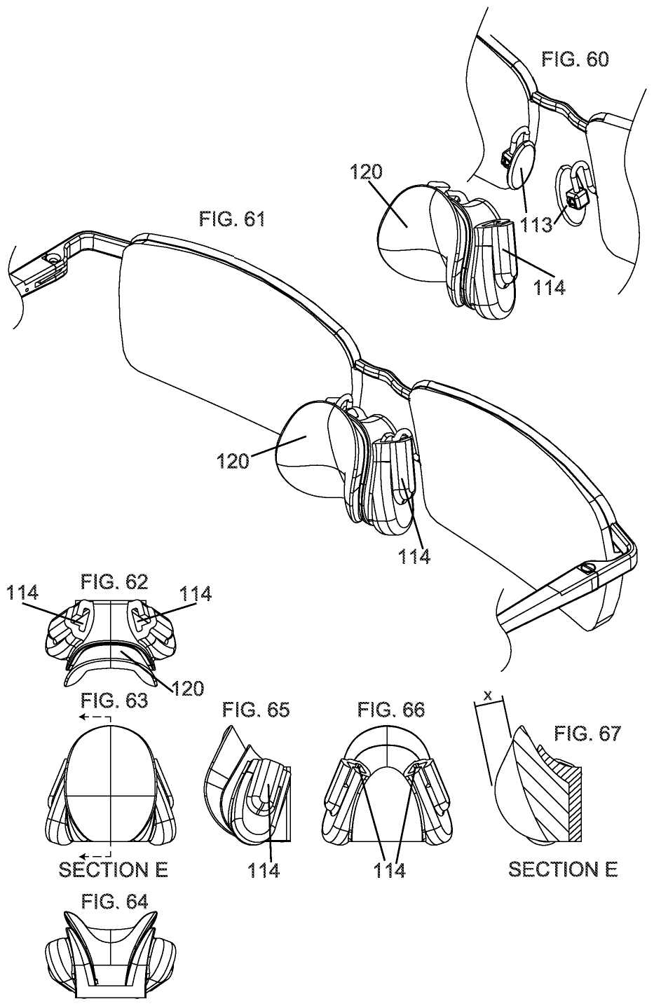

FIGS. 60-67 comprise an implementation of a nose pad 101 design comprising a nosepiece 120 that may be comprised of one or more low durometer materials 108 and that is configured to engage with a nasion and nose of a user to create a secure fit and prevent the eyewear frame 100 from sliding down the nose of the user. As shown in FIGS. 60-62, the nosepiece 120 comprises a pocket 114 on each side of the nosepiece 120 that is adapted to receive a preexisting nose pad 113 of an eyewear frame 100. In some applications, it may be preferable that the interior of the pocket 114 is slightly smaller than the preexisting nose pad 113 as the pocket 114 may be comprised of a deformable material which is then able to stretch to fit over the preexisting nose pad 113 thereby holding the nosepiece 120 securely in place as the nose pad 113 will not easily slide out of the pocket 114. FIG. 67 provides a cross-sectional view along Section E of FIG. 64. As shown, distance x represents a depth of the concavity of the nosepiece 120 into which the user's nose rests when the nosepiece 120 is in use. To provide a user with a variety of custom fits to meet the user's preferences, this distance x may vary to better fit noses of various sizes. As shown in the cross-sectional view of FIG. 67, the nosepiece may comprise a softer, lower durometer layer of material 108 that is in contact with the user's nose and a higher durometer material 107 that does not deform as easily as the lower durometer layer 108 and serves to guide the fit of the nosepiece 120.

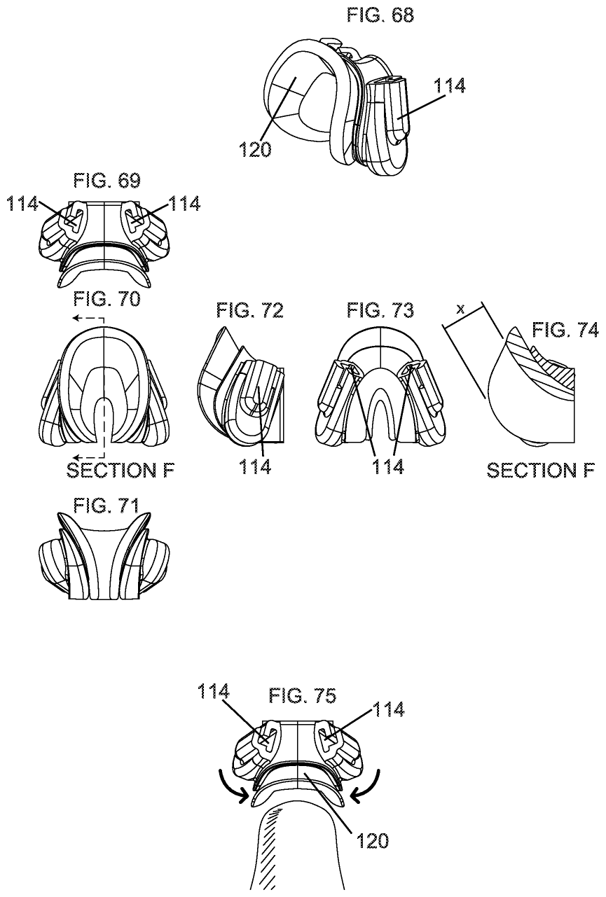

FIGS. 68-75 depict a nosepiece 120 comprising a pocket 114 on each side that is similar to the pockets 114 described relative to FIGS. 60-67, however, the implementation of FIGS. 68-75 comprises a larger distance x along the cross-sectional view along Section F. This results in a larger concavity of the nosepiece 120 into which the user's nose may rest. This saddle-like U-shape of the nosepiece 120 allows users having larger noses to be properly accommodated for a secure fit to the overall eyewear system. As shown in FIG. 75, as the user's nose rests within the concavity of the nosepiece 120, the sides of the nosepiece 120, which are comprised of at least one soft, low durometer material 108, press inward on the nose thereby creating friction which prevents slippage of the eyewear frame 100 on the nose of the user.

It will be understood that implementations are not limited to the specific components disclosed herein, as virtually any components consistent with the intended operation of a method and/or system implementation for eyewear may be utilized. Accordingly, for example, although eyewear systems may be disclosed, such components may comprise any shape, size, style, type, model, version, class, grade, measurement, concentration, material, weight, quantity, and/or the like consistent with the intended operation of a method and/or system implementation for eyewear may be used. In places where the description above refers to particular implementations of eyewear, it should be readily apparent that a number of modifications may be made without departing from the spirit thereof and that these implementations may be applied to other eyewear systems.

1. A slip-resistant eyewear system comprising:
a nose pad comprising:
a securing member configured to couple to a portion of an eyewear frame;
and
a flap pivotally coupled to the securing member, wherein an angle formed between the securing member and the flap is an acute angle.

2. The slip-resistant eyewear system of claim 1, wherein the flap is configured to pivot toward the securing member when the eyewear frame is worn by a user.

3. The slip-resistant eyewear system of claim 1, wherein the flap is comprised of a material having a durometer range of less than about Shore 40A on the Shore A hardness scale.

4. The slip resistant eyewear system of claim 1 wherein the securing member and the flap are integrally formed.

5. The slip-resistant eyewear system of claim 1, wherein the securing member is substantially planar and further comprises an adhesive configured to adhere to the portion of the eyewear frame.

6. The slip-resistant eyewear system of claim 5, wherein the securing member is configured to seat within a notched indentation on the eyewear frame.

7. The slip-resistant eyewear system of claim 1, wherein the nose pad is comprised of a core comprised of a material having a durometer range greater than about Shore 40A on the Shore A hardness scale.

8. The slip-resistant eyewear system of claim 7, wherein the nose pad is comprised of an outer layer comprising a material having a durometer less than about Shore 40A on the Shore A hardness scale.

9. The slip-resistant eyewear system of claim 1, wherein the flap comprises a bulbous tip.

10. The slip-resistant eyewear system of claim 1, wherein the flap comprises a tapered tip.

11. The slip-resistant eyewear system of claim 1, wherein the securing member comprises a plurality of slots.

12. The slip-resistant eyewear system of claim 1, wherein the securing member comprises a pocket configured to house a pre-existing nose pad coupled to the eyewear frame.

13. The slip-resistant eyewear system of claim 1, wherein the securing member comprises a hollow portion.

14. The slip-resistant eyewear system of claim 1, wherein a hinge between the securing member and the flap comprises one or more notches.

15. The slip-resistant eyewear system of claim 1, wherein a hinge between the securing member and the flap comprises one or more slots.

16. The slip-resistant eyewear system of claim 1, wherein the flap further comprises one or more ribs on a surface of the flap that faces the securing member.

17. A method of making a slip-resistant eyewear system, the method comprising:
forming a nose pad, the nose pad comprising:
a securing member configured to couple to a portion of an eyewear frame; and
a flap pivotally coupled to the securing member, wherein an angle formed between the securing member and the flap is an acute angle; and
coupling the securing member to the eyewear frame.

18. The method of claim 17, wherein the flap is configured to pivot toward the securing member when the eyewear frame is worn by a user.

19. The method of claim 17, further comprising adhering the securing member to the portion of the eyewear frame using an adhesive.

20. The method of claim 17, further comprising seating a pre-existing nose pad of the eyewear frame within a pocket of the securing member.
